(19) United States
(12) Patent Application Publication
(10) Pub. No.: US 2023/0122746 A1
(43) Pub. Date: Apr. 20, 2023

(54) System and method for enabling secure web access

(71) Applicants: Mikhael Balin, Tel Aviv (IL); Pesah Spector, Tel Aviv (IL)

(72) Inventors: Mikhael Balin, Tel Aviv (IL); Pesah Spector, Tel Aviv (IL)

(21) Appl. No.: 17/505,626

(22) Filed: Oct. 20, 2021

(51) Int. Cl. H04L 29/06; H04L 12/863

(52) U.S. Cl. CPC H04L 63/0414; H04L 47/6225; H04L 63/20; H04L 63/107; H04L 63/0281

(57) ABSTRACT

The present invention relates to networking technologies, specifically the disclosed invention enables clients or customers to anonymously access web using a privately held web device. Generally, web client identity hiding has multiple commercial usages in internet community such as protecting computer privacy, facilitating web scrapping activities and allowing geo-blocking bypass. The object of the present invention is to hide web identity that further requires hiding of a web client IP address. IP address used to uniquely identify a web client. The present invention addresses some of the problems of hiding internet (IP) identity by enabling hiding of identity using approach that is an alternative to a Virtual Private Network (VPN) method. Specifically, the disclosed invention provides a web service, that hides internet (IP) identity and geo location of a web client or customer from an operator/owner of a website.

### CROSS-REFERENCE TO RELATED APPLICATION

No related applications are previously filed.

A system and method for enabling secure web access

### FIELD OF THE INVENTION

The present invention relates to networking technologies, specifically the disclosed invention enables clients or customers to anonymously access web using a privately held web device.

### BACKGROUND OF THE INVENTION

The Internet is a worldwide network of interconnected computer networks that interact with one another using the Internet protocol suite (TCP/IP). It is a network of networks made up of local to global private, public, academic, corporate, and government networks linked by a variety of electrical, wireless, and optical networking technologies. The Internet provides access to a diverse set of information resources and services, including the World Wide Web’s (WWW) interconnected hypertext documents and applications, electronic mail, telephony, and file sharing. The Hypertext Transfer Protocol (HTTP), which is used to load web pages via hypertext links, is the foundation of the World Wide Web. HTTP is an application layer protocol that operates on top of other layers of the network protocol stack to transport data between networked devices. A typical HTTP flow comprises a client sending a request to a server, which then responds with a message. In the client-server computer model, HTTP serves as a request-response protocol. A web browser, for example, can act as the client, while a programme running on a computer that hosts a website can act as the server. The client sends the server an HTTP request message. The server sends a response message to the client after providing resources such as HTML files and other material or performing other activities on the client’s behalf. The answer provides request completion status information as well as requested material in its message body. A user agent is something like a web browser (UA). Indexing software used by search providers (web crawlers), voice browsers, mobile applications, and other software that accesses, consumes, or displays web material are examples of user agents.

HTTP is intended to allow intermediary network components to enhance or enable client-server connections. Web cache servers, which deliver material on behalf of upstream servers to reduce response time, are frequently used by high-traffic websites. To minimize network traffic, web browsers cache previously visited online pages and reuse them wherever possible. HTTP proxy servers at private network borders can let clients without globally routable addresses communicate by forwarding messages to remote servers.

HTTP is an application layer protocol that was developed within the context of the Internet protocol stack. Its definition presupposes an underlying and trustworthy transport layer protocol, of which Transmission Control Protocol (TCP) is a popular example. However, HTTP may be configured to use untrustworthy protocols such as the User Datagram Protocol (UDP), as shown in HTTPU and the Simple Service Discovery Protocol (SSDP). Uniform Resource Locators (URLs) use the Uniform Resource Identifiers (URIs) schemes http and https to identify and find HTTP resources on the network. URIs are encoded as hyperlinks in HTML pages, as described in RFC 3986, to construct interconnected hypertext documents.

A virtual private network (VPN) connects a private network across a public network, allowing users to transmit and receive data as if their computers were physically linked to the private network. As a result, applications operating through a VPN may benefit from the private network’s functionality, security, and administration. It is usually used by telecommuting professionals to gain access to resources that are not available on the public network. Encryption is a frequent feature of VPN connections; however it is not required. A VPN is built by using dedicated circuits or tunnelling technologies to build a virtual point-to-point connection over existing networks. Some of the benefits of a wide area network can be obtained using a VPN accessible over the public Internet (WAN). The resources accessible within the private network can be accessed remotely from the user’s perspective.

The Advanced Message Queuing Protocol (AMQP) is a message-oriented middleware application layer protocol that is open to the public. Message orientation, queuing, routing (including point-to-point and publish-and-subscribe), reliability, and security are all characteristics of AMQP. Specifically, AMQP mandates messaging provider and client behavior to the extent that implementations from different vendors are interoperable, in the same way that SMTP, HTTP, FTP, and other protocols have created interoperable systems. Previous middleware standardizations at the API level (e.g., JMS) focused on standardizing programmer interaction with different middleware implementations instead of offering interoperability between different implementations. AMQP is a wire-level protocol, unlike JMS, which provides an API and a set of behaviors that a messaging implementation must provide. The format of data sent across the network as a stream of bytes is described by a wire-level protocol. As a result, any tool that can create and read messages that comply to this data format, regardless of implementation language, can communicate with any other conforming tool.

AMQP is a binary application layer protocol that can be used to support a wide range of messaging apps and communication patterns. It offers flow-controlled, message-oriented communication with message-delivery guarantees such as at-most-once (where each message is delivered once or never), at-least-once (where each message is certain to be delivered, but may be delivered multiple times), and precisely (where the message will always certainly arrive and do so only once), as well as authentication and/or encryption based on SASL and/or TLS. It is predicated on the use of a dependable transport layer protocol, such as the Transmission Control Protocol (TCP). The AMQP specification is defined in four layers: (i) a type system, (ii) a symmetric, asynchronous protocol for message transmission from one process to another, (iii) a standard, extensible message format, and (iv) a collection of standardized but extensible ‘messaging capabilities.’

RabbitMQ is an open-source message broker software (also known as message-oriented middleware) that was developed to support the Advanced Message Queuing Protocol (AMQP) and has since been extended with a plug-in architecture to support STOMP, MQ Telemetry Transport (MQTT), and other protocols. Specifically, RabbitMQ is an open source queueing system that is quick and dependable. It’s written in Erlang, a functional language with a reputation for distributed, high-availability, and fault-tolerant applications.

The present invention addresses an array of problems some of which are described below. Specifically, the disclosed invention provides a web service, that hides internet (IP) identity and geo location of a web client or customer from an operator/owner of a website. Generally, web client identity hiding has multiple commercial usages in internet community such as protecting computer privacy, facilitating web scrapping activities and allowing geo-blocking bypass.

The object of the present invention is to hide web identity that further requires hiding of a web client IP address. IP address used to uniquely identify a web client.

Yet another object of the present invention is not to provide the web identity and further enables users or clients to hide the web client’s geo position, e.g. country & county/city.

The further object of the present invention is that the web client is impersonated by a device in a middle. The middle device has an IP address provided by Internet Service Provider (ISP) and when web service receives its request, it learns from IP of the geo location of a middle device.

Yet another object of the present invention is to allow controlling the location of the middle device by routing web requests to a middle device that is located in a desired geo region.

These and many other problems have been long identified. Different solutions to the problems have been tried. However there exists no comprehensive solution to all the above problems.

Therefore, the object of the invention overcomes the limitations and drawbacks from the prior art. To achieve above and other objects, the present invention anticipates a new and entirely different method that resolves the limitations and drawbacks.

The present invention addresses some of the problems of hiding internet (IP) identity by enabling hiding of identity using approach that is an alternative to a Virtual Private Network (VPN) method. The provided system and method offers ultimate mascaraing by using a privately held web device (also called as middle) such as a desktop PC, a laptop, a smart phone or a smartwatch with web access. The software agent that is installed on a middle device is used to combine the agent’s web activity with activity initiated by an owner of a middle device. The present invention doesn’t claim the use of privately held web devices to support the identity hiding as it is a well-known prior art. However, the present invention claims the unique method employed to deliver web request from web client to web sites via network of such middle devices. Additionally, the disclosed invention enables forwarding of requests and replies based entirely on AMQP protocol.

### SUMMARY OF THE INVENTION

The object of the present invention is to provide a system and method that uses a well-known paradigm of a device in the middle that circumvents the request from some web client, making the targeted web service assume that the request originated in the middle. The proposed system and method efficiently hides web client’s internet identity and its geo location. Additionally, the disclosed invention stipulates how to make the middle device without infringing existing patented technologies. It is achieved by combining prior art technologies and the proposed unique solution based on the AMQP protocol.

In accordance with one or more embodiments of the present invention, a system and method for enabling secure web access is disclosed wherein, the system and method enables users to send a standard HTTP/S connect request defined by W3C committee that contains domain/IP address of destinated web service (Host HTTP header) and customer name (Proxy-Authorization HTTP header). The HTTP/S request arrives the service that use HTTP to AMQP converter do obtain the customer identification and converts it using one-function to hide a true identity of an originator. The AMQP converter translates the data in Proxy-Authorization HTTP header to a AMQP queue destination. The customer ID can also include a desired geo of a middle device. If provided, the queue name adjusted to include geo code. The HTTP payload is converted to AMQP message payload. The domain information in Host HTTP header added to AMQP message metadata and sent together with an AMQP payload. The converter then sends the AMQP message to AMQP broker. The message arrives at the AMQP broker that matches the routing queue with the queue name routing the message to a queue correspondingly. One of AMQP subscribers to the queue in previous step, running in a middle device, pulls the message from a queue, obtains from a metadata the domain/IP of a destination WEB server and AMQP message payload. The pulling of a client arranged in a round robin, so every time message reaches a least used consumer of a queue.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 diagrammatically visualizes the elements of the system for enabling secure web access.

FIG. 2 provides flow diagram describing different steps involved in a method for enabling secure web access.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

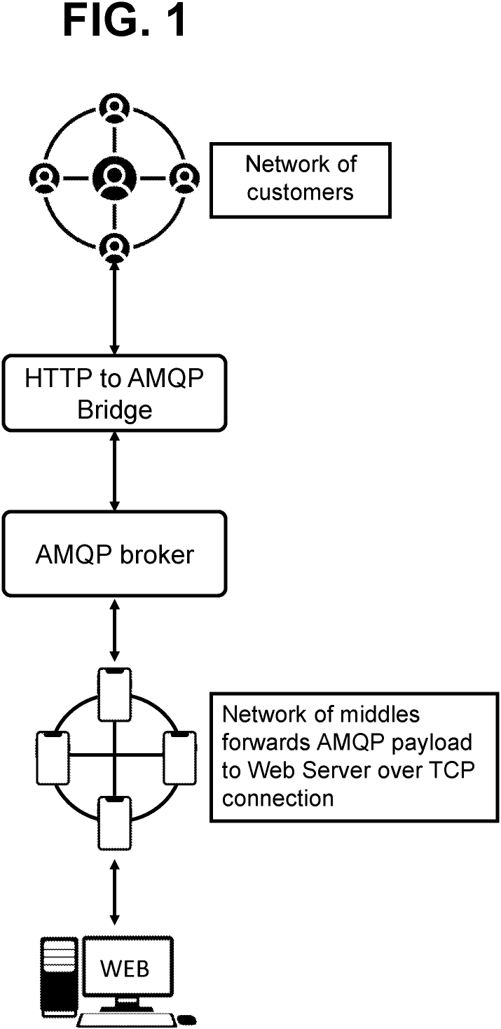

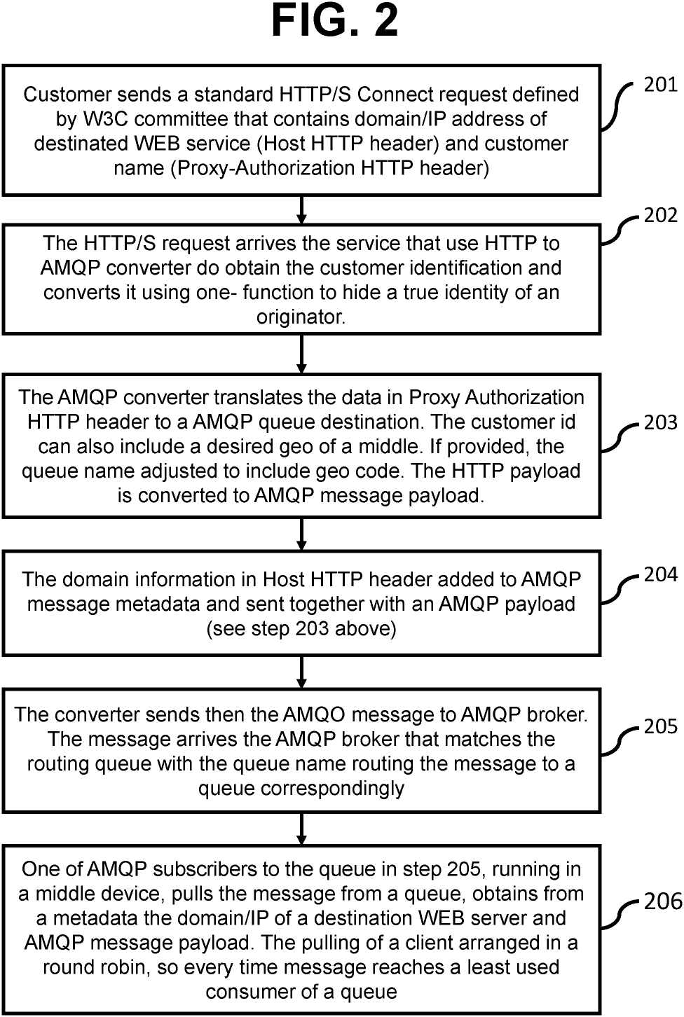

Turning to the figures and specifically FIG. 1, one embodiment of the present invention discloses a system for enabling secure web access, wherein the system comprising a network of customers or clients, at least one HTTP server, an AMQP, a network of middle devices and at least one web server. Now referring to FIG. 2 that provides flow diagram describing the method of enabling secure web access, wherein the method comprises steps of customer sending a standard HTTP/S connect request defined by W3C committee that contains domain/IP address of destinated WEB service (Host HTTP header) and customer name (Proxy-Authorization HTTP header) 201, receiving the HTTP/S request at the service that use HTTP to AMQP converter do obtain the customer identification and converting it using one-function to hide a true identity of an originator 202, translating the data using the AMQP converter in Proxy Authorization HTTP header to a AMQP queue destination wherein the customer ID can also include a desired geo of a middle and if provided, the queue name adjusted to include geo code and the HTTP payload is converted to AMQP message payload 203, adding domain information in Host HTTP header to AMQP message metadata and sending together with an AMQP payload 204, sending the AMQP message using the convertor to AMQP broker and message arrives the AMQP broker that matches the routing queue with the queue name routing the message to a queue correspondingly 205, and queuing one of the AMQP subscribers that are running in a middle device, pulling the message from a queue, obtaining from a metadata the domain/IP of a destination WEB server and AMQP message payload wherein the pulling of a client arranged in a round robin, so every time message reaches a least one used consumer of a queue 206.

In another embodiment of the present invention, a computer-readable storage device having computer-executable instructions stored thereon that, if executed by a computing device, cause the computing device to perform a method comprising steps of: customer sending a standard HTTP/S connect request defined by W3C committee that contains domain/IP address of destinated WEB service (Host HTTP header) and customer name (Proxy-Authorization HTTP header); receiving the HTTP/S request at the service that use HTTP to AMQP converter do obtain the customer identification and converting it using one-function to hide a true identity of an originator; translating the data using the AMQP converter in Proxy Authorization HTTP header to a AMQP queue destination wherein the customer ID can also include a desired geo of a middle and if provided, the queue name adjusted to include geo code and the HTTP payload is converted to AMQP message payload; adding domain information in Host HTTP header to AMQP message metadata and sending together with an AMQP payload 204, sending the AMQP message using the convertor to AMQP broker and message arrives the AMQP broker that matches the routing queue with the queue name routing the message to a queue correspondingly; and queuing one of the AMQP subscribers that are running in a middle device, pulling the message from a queue, obtaining from a metadata the domain/IP of a destination web server and AMQP message payload wherein the pulling of a client arranged in a round robin, so every time message reaches a least one used consumer of a queue.

In the same embodiment of the present invention, use of an Advanced Message Queuing Protocol (e.g., AMQP) to disconnect between HTTP customers and HTTP servers is disclosed. The AMQP protocol addressing is not based in IP identity and it implements a different addressing system. It is not possible to infer the IP identity of a sender from address used in AMQP protocol since AMQP implements scheme of producers/consumers vs peer to peer association implemented in HTTP.

In the same embodiment of the present invention, using one-way hash function by a HTTP to AMQP converter (aka HTTP2AMQPC) to produce AMQP token from a customer identity embedded in HTTP Proxy-Authorization header is disclosed. The AMQP token is used as a name of an AMQP message queue to where, the HTTP2AMQPC sends a HTTP request payload converted to an AMQP message. The one-way crypto function hides the real identity of a customer and cannot be reversed later to learn the identity of a customer

In the same embodiment of the present invention, messages are exchanged between a network of customers and a network of middles through AMQP message brokers. In result it disconnects the message originator (an HTTP client) to a middle (an AMQP subscriber) by means of a protocol change

In the same embodiment of the present invention, using AMQP direct routing to round robin messages between subscribers of a queue, allowing customer hide its identity behind numerous middles each implementing a role of an AMQP consumer

In the same embodiment of the present invention, using a combination of an AMQP token and a geo position of a middle is disclosed. A middle device in some geo region subscribes to the queue that corresponds to their location. For example, to name a queue, use combination of name and country code. Sending request to a queue that includes a country code makes the message reach middles located in a corresponding country impersonating customer location.

In the same embodiment of the present invention, redunding the need for a HTTP client in a middle device is provided, by employing AMQP metadata that arrives with a message to convey a domain/IP of a targeted web server. A middle device then resolves DNS to IP address and opens a TCP connection to web server using this IP.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is described above with reference to a preferred embodiment. However, those skilled in the art will recognize that changes and modifications may be made in the described embodiment without departing from the nature and scope of the present invention. To the extent that such modifications and variations do not depart from the spirit of the invention, they are intended to be included within the scope thereof.

The invention claimed is:

1. A method of enabling secure web access, wherein the method comprising steps of:
customer sending a standard HTTP/S connect request defined by W3C committee that contains domain/IP address of destinated WEB service (Host HTTP header) and customer name (Proxy-Authorization HTTP header);
receiving the HTTP/S request at the service that use HTTP to AMQP converter do obtain the customer identification and converting it using one-function to hide a true identity of an originator;
translating the data using the AMQP converter in Proxy Authorization HTTP header to a AMQP queue destination wherein the customer ID can also include a desired geo of a middle and if provided, the queue name adjusted to include geo code and the HTTP payload is converted to AMQP message payload;
adding domain information in Host HTTP header to AMQP message metadata and sending together with an AMQP payload 204, sending the AMQP message using the convertor to AMQP broker and message arrives the AMQP broker that matches the routing queue with the queue name routing the message to a queue correspondingly; and
queuing one of the AMQP subscribers that are running in a middle device, pulling the message from a queue, obtaining from a metadata the domain/IP of a destination web server and AMQP message payload wherein the pulling of a client arranged in a round robin, so every time message reaches a least one used consumer of a queue.

2. The method of claim 1, wherein AMQP is specifically used to disconnect between HTTP customers and HTTP servers wherein the said AMQP protocol addressing is not based in IP identity and it implements a different addressing system, and it is not possible to infer the IP identity of a sender from address used in AMQP protocol since AMQP implements scheme of producers/consumers vs peer to peer association implemented in HTTP.

3. The method of claim 1, wherein using one-way hash function by a HTTP to AMQP converter (HTTP2AMQPC) to produce AMQP token from a customer identity embedded in HTTP Proxy-Authorization header and the AMQP token is used as a name of an AMQP message queue to where, the HTTP2AMQPC sends a HTTP request payload converted to an AMQP message and the one-way crypto function hides the real identity of a customer and cannot be reversed later to learn the identity of a customer.

4. The method of claim 1, wherein the said messages are exchanged between a network of customers and a network of middles through AMQP message brokers and in result it disconnects the message originator (an HTTP client) to a middle (an AMQP subscriber) by means of a protocol change.

5. The method of claim 1, wherein using AMQP direct routing to round robin messages between subscribers of a queue, allowing customer to hide their identity behind numerous middles each implementing a role of an AMQP consumer.

6. The method of claim 1, wherein using a combination of an AMQP token and a geo position of the middle device, wherein the said middle device in some geo region subscribes to the queue that corresponds to their location and sending request to a queue that includes a country code makes the message reach middle devices located in a corresponding country impersonating customer location.

7. The method of claim 1, wherein redunding the need for a HTTP client in a middle, by employing AMQP metadata that arrives with a message to convey a domain/IP of a targeted web server, wherein the said middle then resolves DNS to IP address and opens a TCP connection to web server using the said IP.

8. A system for enabling secure web access comprising:
a network of customers or clients;
at least one HTTP server;
an AMQP;
a network of middle devices; and
at least one web server.

9. The system of claim 8, wherein the said system is configured to:
enable customer to send a standard HTTP/S connect request defined by W3C committee that contains domain/IP address of destinated WEB service (Host HTTP header) and customer name (Proxy-Authorization HTTP header);
receive the HTTP/S request at the service that use HTTP to AMQP converter do obtain the customer identification and converting it using one-function to hide a true identity of an originator;
translate the data using the AMQP converter in Proxy Authorization HTTP header to a AMQP queue destination wherein the customer ID can also include a desired geo of a middle and if provided, the queue name adjusted to include geo code and the HTTP payload is converted to AMQP message payload;
add domain information in Host HTTP header to AMQP message metadata and sending together with an AMQP payload 204, sending the AMQP message using the convertor to AMQP broker and message arrives the AMQP broker that matches the routing queue with the queue name routing the message to a queue correspondingly; and
que one of the AMQP subscribers that are running in a middle device, pulling the message from a queue, obtaining from a metadata the domain/IP of a destination web server and AMQP message payload wherein the pulling of a client arranged in a round robin, so every time message reaches a least one used consumer of a queue.

10. The system of claim 8, wherein AMQP is specifically used to disconnect between HTTP customers and HTTP servers wherein the said AMQP protocol addressing is not based in IP identity and it implements a different addressing system, and it is not possible to infer the IP identity of a sender from address used in AMQP protocol since AMQP implements scheme of producers/consumers vs peer to peer association implemented in HTTP.

11. The system of claim 8, wherein using one-way hash function by a HTTP to AMQP converter (HTTP2AMQPC) to produce AMQP token from a customer identity embedded in HTTP Proxy-Authorization header and the AMQP token is used as a name of an AMQP message queue to where, the HTTP2AMQPC sends a HTTP request payload converted to an AMQP message and the one-way crypto function hides the real identity of a customer and cannot be reversed later to learn the identity of a customer.

12. The system of claim 8, wherein the said messages are exchanged between a network of customers and a network of middles through AMQP message brokers and in result it disconnects the message originator (an HTTP client) to a middle (an AMQP subscriber) by means of a protocol change.

13. The system of claim 8, wherein using AMQP direct routing to round robin messages between subscribers of a queue, allowing customer to hide their identity behind numerous middles each implementing a role of an AMQP consumer.

14. The system of claim 8, wherein using a combination of an AMQP token and a geo position of the middle device, wherein the said middle device in some geo region subscribes to the queue that corresponds to their location and sending request to a queue that includes a country code makes the message reach middle devices located in a corresponding country impersonating customer location.

15. A computer-readable storage device having computer-executable instructions stored thereon that, if executed by a computing device, cause the computing device to perform a method comprising steps of:
customer sending a standard HTTP/S connect request defined by W3C committee that contains domain/IP address of destinated WEB service (Host HTTP header) and customer name (Proxy-Authorization HTTP header);
receiving the HTTP/S request at the service that use HTTP to AMQP converter do obtain the customer identification and converting it using one-function to hide a true identity of an originator;
translating the data using the AMQP converter in Proxy Authorization HTTP header to a AMQP queue destination wherein the customer ID can also include a desired geo of a middle and if provided, the queue name adjusted to include geo code and the HTTP payload is converted to AMQP message payload;
adding domain information in Host HTTP header to AMQP message metadata and sending together with an AMQP payload 204, sending the AMQP message using the convertor to AMQP broker and message arrives the AMQP broker that matches the routing queue with the queue name routing the message to a queue correspondingly; and
queuing one of the AMQP subscribers that are running in a middle device, pulling the message from a queue, obtaining from a metadata the domain/IP of a destination web server and AMQP message payload wherein the pulling of a client arranged in a round robin, so every time message reaches a least one used consumer of a queue.

16. The device of claim 15, wherein AMQP is specifically used to disconnect between HTTP customers and HTTP servers wherein the said AMQP protocol addressing is not based in IP identity and it implements a different addressing system, and it is not possible to infer the IP identity of a sender from address used in AMQP protocol since AMQP implements scheme of producers/consumers vs peer to peer association implemented in HTTP.

17. The device of claim 15, wherein using one-way hash function by a HTTP to AMQP converter (HTTP2AMQPC) to produce AMQP token from a customer identity embedded in HTTP Proxy-Authorization header and the AMQP token is used as a name of an AMQP message queue to where, the HTTP2AMQPC sends a HTTP request payload converted to an AMQP message and the one-way crypto function hides the real identity of a customer and cannot be reversed later to learn the identity of a customer.

18. The device of claim 15, wherein the said messages are exchanged between a network of customers and a network of middles through AMQP message brokers and in result it disconnects the message originator (an HTTP client) to a middle (an AMQP subscriber) by means of a protocol change.

19. The device of claim 15, wherein using AMQP direct routing to round robin messages between subscribers of a queue, allowing customer to hide their identity behind numerous middles each implementing a role of an AMQP consumer.

20. The device of claim 15, wherein using a combination of an AMQP token and a geo position of the middle device, wherein the said middle device in some geo region subscribes to the queue that corresponds to their location and sending request to a queue that includes a country code makes the message reach middle devices located in a corresponding country impersonating customer location.
